(19) United States
(12) Patent Application Publication
(10) Pub. No.: US 2023/0065588 A1
(43) Pub. Date: Mar. 2, 2023

(54) APPARATUS FOR DETERMINING ISOLATION DEVICE GROUP USING SIMILARITY OF DEVICE FEATURE AND METHOD USING THE SAME

(71) Applicant: ELECTRONICS AND TELECOMMUNICATIONS RESEARCH INSTITUTE, Daejeon (KR)

(72) Inventors: Seon-Gyoung SOHN, Daejeon (KR); Young-Ho KIM, Daejeon (KR); Jae-Deok LIM, Sejong-si (KR); Kyeong-Tae KIM, Daejeon (KR); Jeong-Nyeo KIM, Daejeon (KR); Yun-Kyung LEE, Daejeon (KR)

(73) Assignee: ELECTRONICS AND TELECOMMUNICATIONS RESEARCH INSTITUTE, Daejeon (KR)

(21) Appl. No.: 17/736,722

(22) Filed: May 4, 2022

(30) Foreign Application Priority Data
Aug. 30, 2021 (KR) 10-2021-0114854

(51) Int. Cl. G06F 21/55; G06F 21/44

(52) U.S. Cl. CPC G06F 21/554; G06F 21/44; G06F 2221/034

(57) ABSTRACT

Disclosed herein are an apparatus for determining a device group to be isolated using similarity of features between devices and a method using the apparatus. The method includes generating device groups in consideration of respective features of all devices, generating a security threat device group based on devices in which a security threat has occurred, among all of the devices, calculating the cosine similarity between the security threat device group and all of the device groups, and determining at least one device group to be isolated, among all of the device groups, in consideration of the cosine similarity.

### CROSS REFERENCE TO RELATED APPLICATION

This application claims the benefit of Korean Patent Application No. 10-2021-0114854, filed Aug. 30, 2021, which is hereby incorporated by reference in its entirety into this application.

### BACKGROUND OF THE INVENTION

### 1. Technical Field

The present invention relates generally to technology for determining a device group to be isolated using similarity of features between devices, and more particularly to Internet-of-Things (IoT) security technology for preventing security threats occurring in an IoT environment from spreading.

### 2. Description of the Related Art

With the continued growth of IoT markets, the number of network-connected IoT devices is increasing exponentially, but it is not easy to include a security function in IoT devices, which are characterized by ultra-low weight, low power, and low performance. A security threat in IoT infrastructure arises from a large number of devices in which no security function is installed or devices that are not appropriately managed by neglecting firmware updates for strengthening weak points. Cases of cyberattacks such as a Mirai botnet, which causes large-scale DDoS attacks using a botnet generated by infecting IoT devices vulnerable to security issues, show that, when a large number of IoT devices are exploited for cyberattacks, the damage can be very severe.

In order to improve the security of IoT infrastructure, various security solutions are applied to respective components of IoT infrastructure pertaining to, for example, devices, networks, services/systems, data/privacy, and the like. Also, a security level and insights into security are improved, but attack methods are also sophisticated, so it is not easy to completely prevent security threats.

A device infected with malicious code configured to convert an IoT device to act as a bot looks for an accessible device having a security vulnerability in the vicinity thereof and spreads the malicious code thereto. A device having features similar to those of the device infected with malicious code is highly likely to be infected with the same malicious code.

A security control device presented in the related art determines an IoT device group to be isolated based on the magnitude of a security threat in a device group in order to prevent a security threat that has broken into IoT infrastructure from proliferating across the entirety of the IoT infrastructure. Here, because the magnitude of a security threat is calculated as a percentage of devices in which the security threat has occurred, among all devices included in a device group, if the same amount of security threat occurs in an additional device group having a large size, the additional device group is not isolated, so the security threat may continuously spread.

### DOCUMENTS OF RELATED ART

(Patent Document 1) Korean Patent Application Publication No. 10-2020-0034594, published on Oct. 7, 2020 and titled “Apparatus and method for security control”.

### SUMMARY OF THE INVENTION

An object of the present invention is to determine a device group having feature information similar to that of devices in which a security threat is detected.

Another object of the present invention is to look for a device group having a high possibility of a security threat occurring therein, notify an administrator of the device group, and take security measures, such as eliminating a vulnerability causing the security threat, isolating the device group from IoT infrastructure, and the like.

In order to accomplish the above objects, a method for determining a device group to be isolated according to the present invention includes generating device groups in consideration of respective features of all devices; generating a security threat device group based on devices in which a security threat has occurred, among all of the devices; calculating cosine similarity between the security threat device group and each of all of the device groups; and determining at least one device group to be isolated, among all of the device groups, in consideration of the cosine similarity.

Here, each of all of the devices may have multiple features, and a single device is capable of being included in multiple device groups depending on features that distinguish the device groups.

Here, generating the device groups may comprise generating the device groups in a number equal to the number of possible combinations of the multiple features.

Here, calculating the cosine similarity may include preprocessing the respective features of all of the devices by extracting and vectorizing the respective features.

Here, preprocessing the features may comprise extracting word tokens corresponding to the features and calculating a relative frequency of occurrence of a word corresponding to each of the word tokens, thereby generating a feature vector.

Here, calculating the cosine similarity may comprise calculating the feature vector for each of the security threat device group and all of the device groups and calculating cosine similarity of the feature vectors between the security threat device group and each of all of the device groups.

Here, the cosine similarity may be represented as a value equal to or greater than ‘0’ and equal to or less than ‘1’, and as the value is greater, a corresponding device group may be determined to be more similar to the security threat device group.

Here, determining the at least one device group to be isolated may comprise determining the device group to be isolated using at least one of a method of selecting any one device group having the highest cosine similarity, among all of the device groups, as the device group to be isolated, a method of selecting a device group having cosine similarity equal to or greater than a preset reference similarity, among all of the device groups, as the device group to be isolated, and a method of selecting the N top device groups, among all of the device groups listed in descending order of cosine similarity, as the device group to be isolated.

Also, an apparatus for determining a device group to be isolated according to an embodiment of the present invention includes a processor for generating device groups in consideration of respective features of all devices, generating a security threat device group based on devices in which a security threat has occurred, among all of the devices, calculating cosine similarity between the security threat device group and each of all of the device groups, and determining at least one device group to be isolated, among all of the device groups, in consideration of the cosine similarity; and memory for storing information about all of the device groups and the security threat device group.

Here, each of all of the devices may have multiple features, and a single device is capable of being included in multiple device groups depending on features that distinguish the device groups.

Here, the processor may generate the device groups in a number equal to the number of possible combinations of the multiple features.

Here, the processor may preprocess the respective features of all of the devices by extracting and vectorizing the respective features.

Here, the processor may extract word tokens corresponding to the features and calculate a relative frequency of occurrence of a word corresponding to each of the word tokens, thereby generating a feature vector.

Here, the processor may calculate the feature vector for each of the security threat device group and all of the device groups and calculate cosine similarity of the feature vectors between the security threat device group and each of all of the device groups.

Here, the cosine similarity may be represented as a value equal to or greater than ‘0’ and equal to or less than ‘1’, and as the value is greater, a corresponding device group may be determined to be more similar to the security threat device group.

Here, the processor may determine the device group to be isolated using at least one of a method of selecting any one device group having the highest cosine similarity, among all of the device groups, as the device group to be isolated, a method of selecting a device group having cosine similarity equal to or greater than a preset reference similarity, among all of the device groups, as the device group to be isolated, and a method of selecting the N top device groups, among all of the device groups listed in descending order of cosine similarity, as the device group to be isolated.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart illustrating a method for determining a device group to be isolated according to an embodiment of the present invention;

FIG. 2 is a view illustrating an example of device groups according to the present invention;

FIG. 3 is a view illustrating an example of a security threat device group according to the present invention;

FIG. 4 is a view illustrating an example of a TF-IDF value for a word token according to the present invention;

FIG. 5 is a view illustrating an example of a feature vector of a device group according to the present invention;

FIG. 6 is a view illustrating an example of cosine similarity according to the present invention;

FIG. 7 is a view illustrating an example of a result of calculation of cosine similarity according to the present invention;

FIG. 8 is a block diagram illustrating an apparatus for determining a device group to be isolated according to an embodiment of the present invention; and

FIG. 9 is a block diagram illustrating an apparatus for determining a device group to be isolated according to another embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

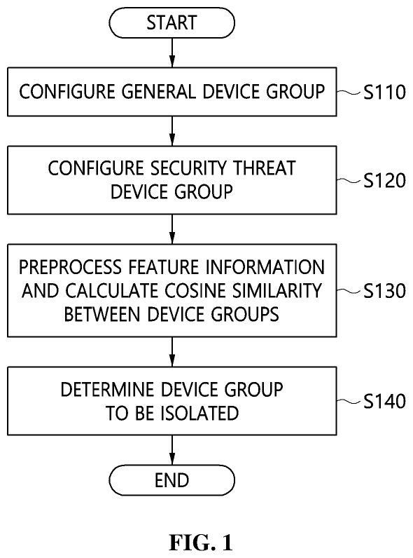

FIG. 1 is a flowchart illustrating a method for determining a device group to be isolated according to an embodiment of the present invention.

Referring to FIG. 1, in the method for determining a device group to be isolated according to an embodiment of the present invention, device groups are generated at step S110 in consideration of features of all devices.

Here, a device group may be a collection of devices having the same features.

Here, each of the devices has multiple features, and a single device is capable of being included in multiple device groups depending on the features that distinguish the device groups.

Here, a number of device groups equal to the number of possible combinations of multiple features may be generated.

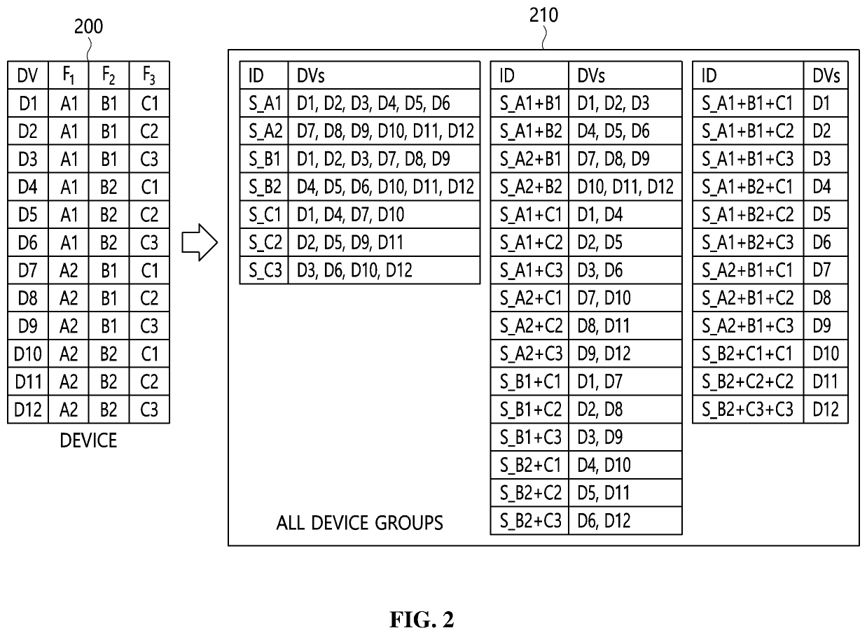

For example, assume that a total of twelve devices having features F₁, F₂, and F₃ constitute all devices 200, as shown in FIG. 2. If each device group is configured based on a single feature, a number of device groups equal to the sum of the numbers of respective possible values of feature F₁, F₂, and F₃ may be generated. Among all of the device groups 210 illustrated in FIG. 2, device groups having IDs of S_A1, S_A2, S_B1, S_B2, S_C1,S_C2, and S_C3 may correspond thereto.

If each device group is configured based on a combination of two features, a device group may be generated by collecting devices having the same values for each of two features, among F₁, F₂, and F₃. That is, device groups may be generated based on a combination of possible values of F₁ and F₂, a combination of possible values of F₁ and F₃, and a combination of possible values of F₂ and F₃, and among all of the device groups 210 illustrated in FIG. 2, devices groups having IDs of S_A1+B1, S_A1+B2, S_A2+B1, S_A2+B2, S_A1+C1, S_A1+C2, S_A1+C3, S_A2+C1, S_A2+C2, S_A2+C3, S_B1+C1, S_B1+C2, S_B1+C3, S_B2+C1, S_B2+C2, and S_B2+C3 may correspond thereto. For example, the device group having an ID of S_B2+C3 may be configured by collecting all of the devices having both B2 and C3 as feature values thereof into a single group.

If each device group is configured based on a combination of three features, a device group may be generated by collecting devices having the same values for each of features F₁, F₂, and F₃. Among all of the device groups 210 illustrated in FIG. 2, device groups having IDs of S_A1+B1+C1, S_A1+B1+C2, S_A1+B1+C3, S_A1+B2+C1, S_A1+B2+C2, S_A1+B2+C3, S_A2+B1+C1, S_A2+B1+C2, S_A2+B1+C3, S_A2+B2+C1, S_A2+B2+C2, and S_A2+B2+C3 may correspond thereto.

Here, the features of all of the devices may be preprocessed by extracting and vectorizing the same.

Here, word tokens corresponding to the features are extracted, and the relative frequency of occurrence of a word corresponding to each of the word tokens is calculated, whereby a feature vector may be generated.

Because features of a device are typically text information, it is necessary to convert the same into a numerical format before processing. Therefore, using a Term Frequency-Inverse Document Frequency (TF-IDF) algorithm, which is commonly used to calculate similarity between documents or to extract important words from a document, a word token is extracted from a feature and the relative frequency of occurrence of the word is calculated, whereby a feature vector may be generated.

Here, other text vectorization algorithms, such as an algorithm based on the frequency of occurrence of a word token and the like, may be used instead of the TF-IDF algorithm.

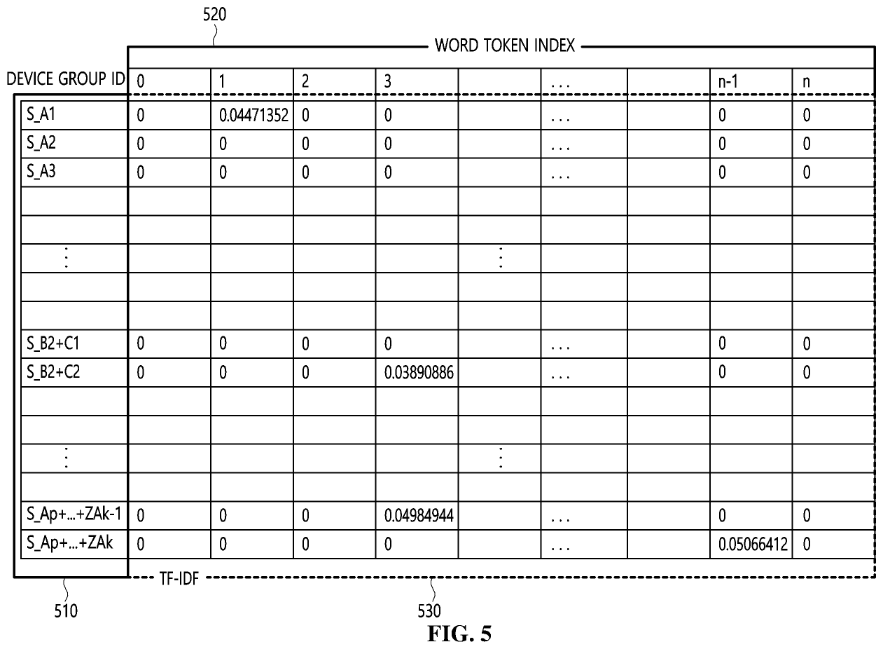

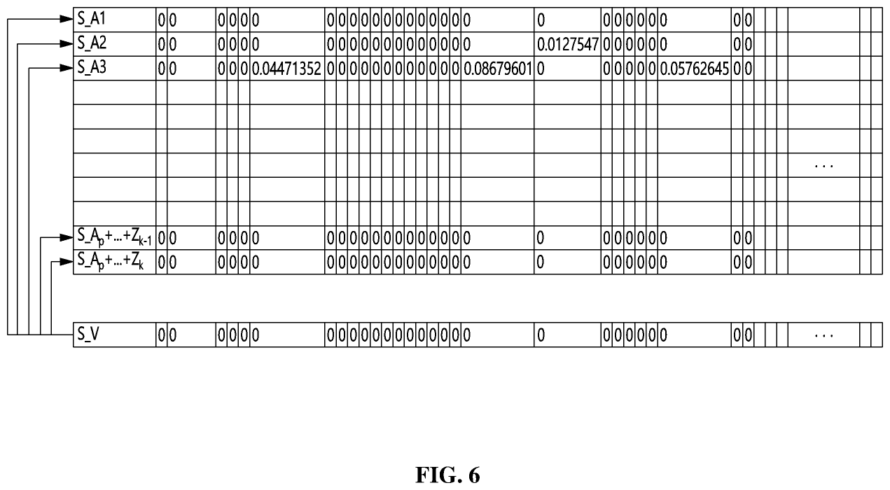

For example, as shown in FIG. 4, TF-IDF values may be generated for respective word tokens for all words included in the features of devices, and feature vectors for device groups may be generated using the generated TF-IDF values, as shown in FIG. 5.

Also, in the method for determining a device group to be isolated according to an embodiment of the present invention, a security threat device group is generated at step S120 based on devices in which a security threat has occurred, among all of the devices.

Here, devices in which a specific security threat has occurred in a fixed time period are collected into a separate device group, whereby a security threat device group may be generated.

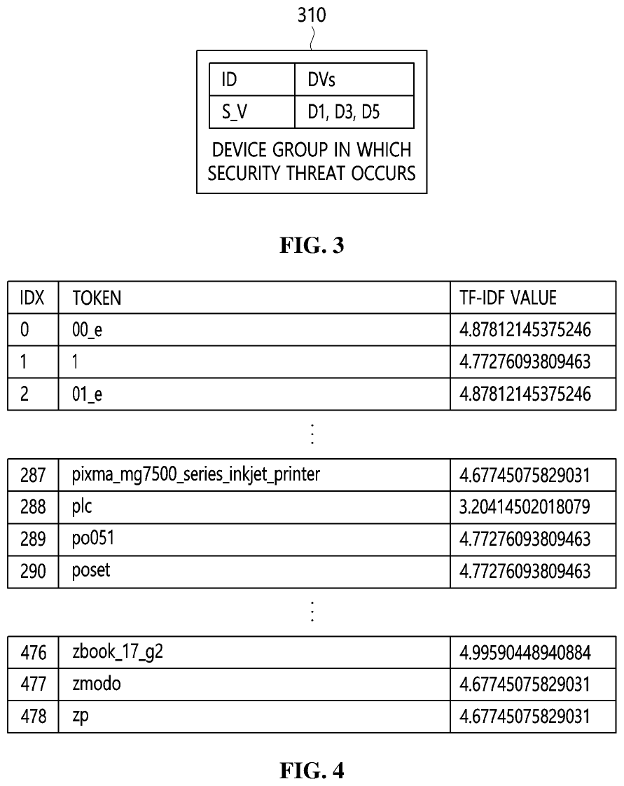

For example, assuming that a security threat has occurred in D1, D3, and D5, among all of the devices 200 illustrated in FIGS. 2, D1, D3, and D5 are grouped as shown in FIG. 3, whereby a security threat device group may be generated.

Also, in the method for determining a device group to be isolated according to an embodiment of the present invention, the cosine similarity between the security threat device group and all of the device groups is calculated at step S130.

Here, a feature vector is calculated for each of the security threat device group and all of the device groups, and the cosine similarity of the feature vectors between the security threat device group and each of all of the device groups may be calculated.

Here, the cosine similarity is represented as a value equal to or greater than ‘0’ and equal to or less than ‘1’, and the greater the value, the more similar the device groups between which the cosine similarity is calculated.

That is, the similarity between the feature of the security threat device group and that of each of the device groups may be represented as a value ranging from 0 to 1.

Here, if the value of the cosine similarity is ‘1’, two vectors are the same as each other, and thus the two device groups may be determined to be the same as each other.

For example, the cosine similarity between the security threat device group S_V and each of all of the device groups may be calculated, as shown in FIG. 6.

Also, in the method for determining a device group to be isolated according to an embodiment of the present invention, at least one device group to be isolated is selected from among all of the device groups in consideration of the cosine similarity at step S140.

Here, the device group to be isolated may be determined using at least one of a method of selecting any one device group having the highest cosine similarity, among all of the device groups, as the device group to be isolated, a method of selecting a device group having cosine similarity equal to or greater than a preset reference similarity, among all of the device groups, as the device group to be isolated, and a method of selecting the N top device groups, among all of the device groups listed in descending order of cosine similarity, as the device group to be isolated.

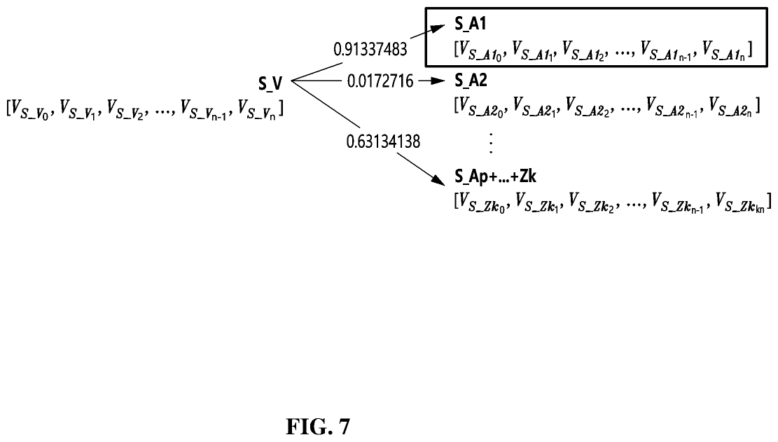

For example, as shown in FIG. 7, when the similarity values between the security threat device group S_V and all of the devices groups S_A1, S_A2, . . . , S_Ap+ . . . +Zk are calculated, if the similarity value between the security threat device group S_V and the device group S_A1 is the largest, the device group S_A1 may be determined to have features similar to those of the device group in which a security threat has currently occurred, and may be inferred to have a high possibility of a security threat occurring therein. Accordingly, the device group S_A1 may be selected as the device group to be isolated.

Through the above-described method for determining a device group to be isolated, a device group having feature information similar to that of devices in which a security threat is detected may be determined.

Also, a device group having a high possibility of a security threat occurring therein is found and made known to an administrator, whereby security measures, such as eliminating the vulnerability causing the security threat, isolating the device group from IoT infrastructure, and the like, may be taken.

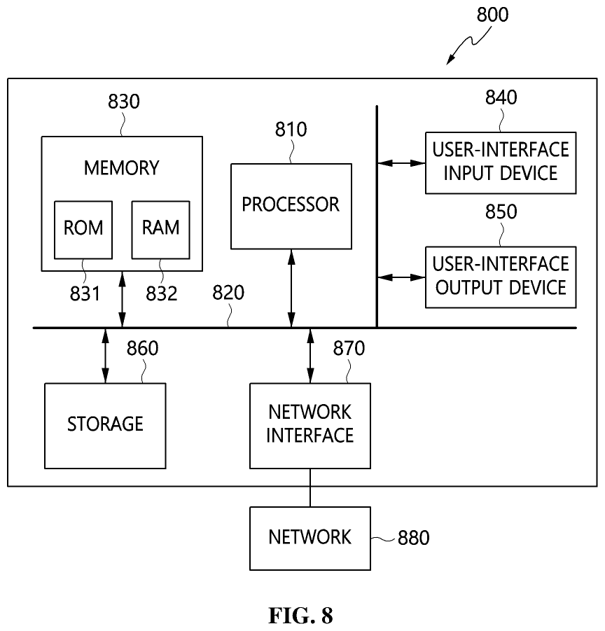

FIG. 8 is a block diagram illustrating an apparatus for determining a device group to be isolated according to an embodiment of the present invention.

Referring to FIG. 8, the apparatus for determining a device group to be isolated according to an embodiment of the present invention may be implemented in a computer system including a computer-readable recording medium. As illustrated in FIG. 8, the computer system 800 may include one or more processors 810, memory 830, a user-interface input device 840, a user-interface output device 850, and storage 860, which communicate with each other via a bus 820. Also, the computer system 800 may further include a network interface 870 connected to a network 880. The processor 810 may be a central processing unit or a semiconductor device for executing processing instructions stored in the memory 830 or the storage 860. The memory 830 and the storage 860 may be any of various types of volatile or nonvolatile storage media. For example, the memory may include ROM 831 or RAM 832.

Accordingly, an embodiment of the present invention may be implemented as a non-transitory computer-readable storage medium in which methods implemented using a computer or instructions executable in a computer are recorded. When the computer-readable instructions are executed by a processor, the computer-readable instructions may perform a method according to at least one aspect of the present invention.

The processor 810 generates device groups in consideration of the features of all devices.

Here, each of the devices has multiple features, and a single device is capable of being included in multiple device groups depending on the features that distinguish the device groups.

Here, a number of device groups equal to the number of possible combinations of multiple features may be generated.

Here, the features of all of the devices may be preprocessed by extracting and vectorizing the same.

Here, word tokens corresponding to the features are extracted, and the relative frequency of occurrence of a word corresponding to each of the word tokens is calculated, whereby a feature vector may be generated.

Also, the processor 810 generates a security threat device group based on devices in which a security threat has occurred, among all of the devices.

Also, the processor 810 calculates the cosine similarity between the security threat device group and each of all of the device groups.

Here, a feature vector is calculated for each of the security threat device group and all of the device groups, and the cosine similarity of the feature vectors between the security threat device group and each of all of the device groups may be calculated.

Here, the cosine similarity is represented as a value equal to or greater than ‘0’ and equal to or less than ‘1’, and the greater the value, the more similar the two device groups between which the cosine similarity is calculated.

Also, the processor 810 selects at least one device group to be isolated, among all of the device groups, in consideration of the cosine similarity.

Here, the device group to be isolated may be determined using at least one of a method of selecting any one device group having the highest cosine similarity, among all of the device groups, as the device group to be isolated, a method of selecting a device group having cosine similarity equal to or greater than a preset reference similarity, among all of the device groups, as the device group to be isolated, and a method of selecting the N top device groups, among all of the device groups listed in descending order of cosine similarity, as the device group to be isolated.

The memory 830 and the storage 860 store information about all of the device groups and the security threat device group.

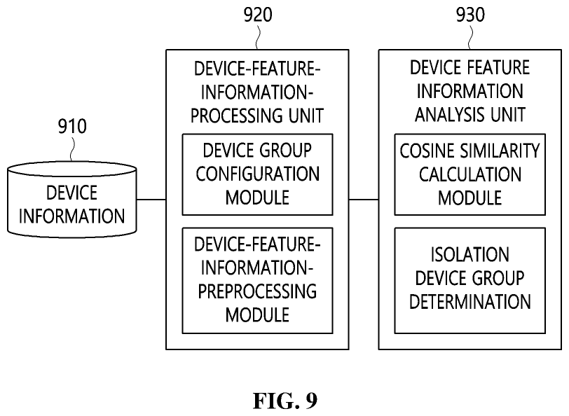

FIG. 9 illustrates an apparatus for determining a device group to be isolated according to another embodiment of the present invention, and the apparatus for determining a device group to be isolated may include device information 910, a device-feature-information-processing unit 920, and a device feature information analysis unit 930.

The device-feature-information-processing unit 920 may include a device group configuration module for configuring a device group based on feature information in the device information 910 and a device-feature-information-preprocessing module for preprocessing feature information of a device by extracting and vectorizing the same.

The device feature information analysis unit 930 may include a cosine similarity calculation module for calculating cosine similarity between devices in which a security threat has occurred and existing device groups and an isolation device group determination module for determining a device group to be isolated based on a similarity score.

According to the present invention, a device group having feature information similar to that of devices in which a security threat is detected may be determined.

Also, according to the present invention, an administrator is notified of a device group having a high possibility of a security threat occurring therein, whereby security measures, such as eliminating the vulnerability causing the security threat, isolating the device group from IoT infrastructure, and the like, may be taken.

As described above, the apparatus for determining a device group to be isolated using similarity of features between devices and the method using the apparatus according to the present invention are not limitedly applied to the configurations and operations of the above-described embodiments, but all or some of the embodiments may be selectively combined and configured, so the embodiments may be modified in various ways.

What is claimed is:

1. A method for determining a device group to be isolated, comprising:
generating device groups in consideration of respective features of all devices;
generating a security threat device group based on devices in which a security threat has occurred, among all of the devices;
calculating a cosine similarity between the security threat device group and each of all of the device groups; and
determining at least one device group to be isolated, among all of the device groups, in consideration of the cosine similarity.

2. The method of claim 1, wherein:
each of all of the devices has multiple features, and a single device is capable of being included in multiple device groups depending on features that distinguish the device groups.

3. The method of claim 2, wherein:
generating the device groups comprises generating the device groups in a number equal to a number of possible combinations of the multiple features.

4. The method of claim 1, wherein:
calculating the cosine similarity includes preprocessing the respective features of all of the devices by extracting and vectorizing the respective features.

5. The method of claim 4, wherein:
preprocessing the features comprises extracting word tokens corresponding to the features and calculating a relative frequency of occurrence of a word corresponding to each of the word tokens, thereby generating a feature vector.

6. The method of claim 5, wherein:
calculating the cosine similarity comprises calculating the feature vector for each of the security threat device group and all of the device groups and calculating a cosine similarity of the feature vectors between the security threat device group and each of all of the device groups.

7. The method of claim 1, wherein:
the cosine similarity is represented as a value equal to or greater than ‘0’ and equal to or less than ‘1’, and as the value is greater, a corresponding device group is determined to be more similar to the security threat device group.

8. The method of claim 1, wherein:
determining the at least one device group to be isolated comprises determining the device group to be isolated using at least one of a method of selecting any one device group having a highest cosine similarity, among all of the device groups, as the device group to be isolated, a method of selecting a device group having a cosine similarity equal to or greater than a preset reference similarity, among all of the device groups, as the device group to be isolated, and a method of selecting the N top device groups, among all of the device groups listed in descending order of a cosine similarity, as the device group to be isolated.

9. An apparatus for determining a device group to be isolated, comprising:
a processor for generating device groups in consideration of respective features of all devices, generating a security threat device group based on devices in which a security threat has occurred, among all of the devices, calculating a cosine similarity between the security threat device group and each of all of the device groups, and determining at least one device group to be isolated, among all of the device groups, in consideration of the cosine similarity; and
memory for storing information about all of the device groups and the security threat device group.

10. The apparatus of claim 9, wherein:
each of all of the devices has multiple features, and a single device is capable of being included in multiple device groups depending on features that distinguish the device groups.

11. The apparatus of claim 10, wherein:
the processor generates the device groups in a number equal to a number of possible combinations of the multiple features.

12. The apparatus of claim 9, wherein:
the processor preprocesses the respective features of all of the devices by extracting and vectorizing the respective features.

13. The apparatus of claim 12, wherein:
the processor extracts word tokens corresponding to the features and calculates a relative frequency of occurrence of a word corresponding to each of the word tokens, thereby generating a feature vector.

14. The apparatus of claim 13, wherein:
the processor calculates the feature vector for each of the security threat device group and all of the device groups and calculates a cosine similarity of the feature vectors between the security threat device group and each of all of the device groups.

15. The apparatus of claim 9, wherein:
the cosine similarity is represented as a value equal to or greater than ‘0’ and equal to or less than ‘1’, and as the value is greater, a corresponding device group is determined to be more similar to the security threat device group.

16. The apparatus of claim 9, wherein:
the processor determines the device group to be isolated using at least one of a method of selecting any one device group having a highest cosine similarity, among all of the device groups, as the device group to be isolated, a method of selecting a device group having a cosine similarity equal to or greater than a preset reference similarity, among all of the device groups, as the device group to be isolated, and a method of selecting the N top device groups, among all of the device groups listed in descending order of a cosine similarity, as the device group to be isolated.
